(19) United States
(12) Patent Application Publication
(10) Pub. No.: US 2007/0107513 A1
(43) Pub. Date: May 17, 2007

(54) METHOD AND APPARATUS FOR LIQUID LEVEL MEASUREMENT OF FUEL CELL

(76) Inventors: Chun-Chin Tung, Chupei (TW); An-Sheng Fan, Chupei (TW)

Correspondence Address: G. LINK CO., LTD., 3550 BELL ROAD, MINOOKA, IL, 60447, US

(21) Appl. No.: 11/537,652

(22) Filed: Oct. 1, 2006

(30) Foreign Application Priority Data
Nov. 9, 2005 (TW) 094139287

(51) Int. Cl. G01F 23/00

(52) U.S. Cl. 73/290 R

(57) ABSTRACT

The present invention relates to a method and an apparatus for measuring the liquid level in a container of a fuel cell, comprising: a container, a plurality of sensors and a circuit device. The container has a chamber for storing the liquid fuel. These sensors are respectively electrically connected to the circuit device and respectively comprise means for measuring the liquid level, so as to provide the liquid level information. The circuit device has a logical calculator for converting the electrical signal related to the liquid level information into the electrical signal related to the quantity of the liquid fuel. By measuring the liquid level via these respective sensors, a plurality of reference points corresponding to the liquid level can be obtained, and the amount of the liquid fuel remaining in the container can be determined by means of conversion of the electrical signal related to respective reference points by the logical calculator of the circuit device.

### FIELD OF THE INVENTION

The present invention relates to a method and an apparatus for measuring the liquid level in a container of a fuel cell, and more particularly to a plurality of liquid level sensors and a logical calculator provided for determining the liquid level and the quantity of liquid fuel remaining in the container of the fuel cell.

### BACKGROUND OF THE INVENTION

Conventional fuel cells use hydrogen-rich fuel, such as methanol, to conduct an electrochemical reaction with oxygen, so as to generate electrical power output. In the field of micro-fuel cell applications, it is desired to be noticed when to supply the fuel, therefore, the liquid level and the quantity of the fuel in a container need to be detectable. While the container measured by the present invention is used in a portable electronic product, whose liquid level in the container varies with the movements of the product. The product is not always fixed in the same direction, hence a new liquid level measuring mechanism is provided, so as to be designed for measuring the shifted and turbulent liquid level due to the movements of the product and determining the quantity of the fuel in the container.

In consideration of the deficiencies in the prior art, a method and an apparatus for measuring the liquid level in a container of the fuel cell are invented so as to reach a new mechanism for liquid level measurement.

### SUMMARY OF THE INVENTION

An object of this invention is to provide a method and an apparatus for measuring the liquid level in a container of the fuel cell, so as to measure the liquid level and the quantity of the fuel when the container is set at an angle to the normal horizontal direction.

To achieve the above object, the present invention provides a method and an apparatus for measuring the liquid level in a container of a fuel cell, comprising: a container, a plurality of sensors and a circuit device. The container has a chamber for storing the liquid fuel. These sensors are respectively electrically connected to the circuit device and respectively comprise means for sensing the level of the liquid fuel, so as to provide the liquid level information. The circuit device comprises a logical calculator with means for converting a plurality of electrical signals related to the liquid level information into an electrical signal related to the quantity of the liquid fuel. A plurality of reference points corresponding to the liquid levels are obtained respectively by measuring liquid levels via these sensors respectively. Meanwhile, the remaining amount of the liquid fuel in the container could be determined by means of conversion of these electrical signals related to respective reference points by the logical calculator of the circuit device.

### BRIEF DESCRIPTION OF THE DRAWINGS

The object, other features and advantages of the present invention now will be more apparent to those skilled in the art through the further descriptions of the preferred embodiment with accompanying drawings,wherein:

FIG. 1 illustrates a perspective view of an apparatus for measuring the liquid level in a container of the fuel cell according to the first embodiment of the present invention;

FIG. 2 illustrates a plan view of the apparatus for measuring the liquid level in a container of the fuel cell according to the first embodiment of the present invention;

FIG. 3 illustrates a plan view of a sensor for measuring the liquid level in a container of the fuel cell according to the embodiment of the present invention; and

FIG. 4 illustrates a plan view of the apparatus for measuring the liquid level in a container of the fuel cell according to the second embodiment of the invention.

### DETAILED DESCRIPTION OF THE INVENTION

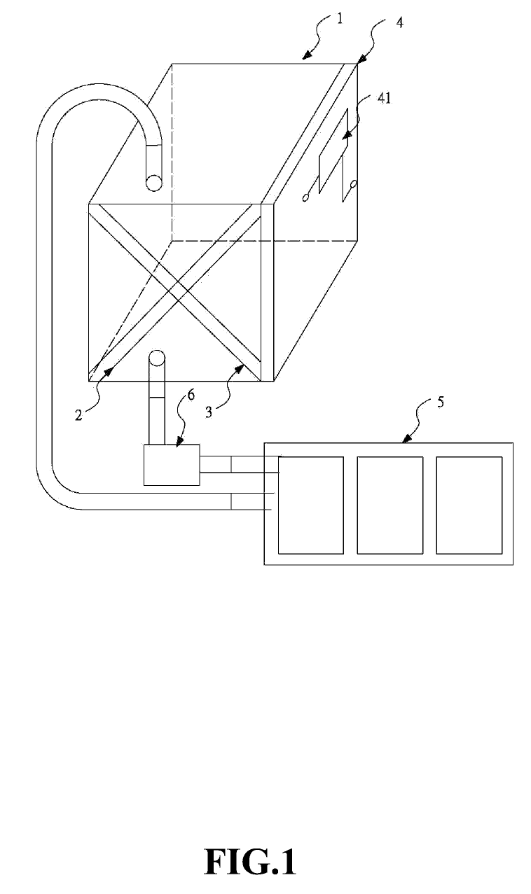

FIG. 1 is a perspective view of an apparatus for measuring the liquid level in a container of the fuel cell according to the first embodiment of the present invention. As shown in the FIG. 1, the apparatus comprises a container (1), a first sensor (2), a second sensor (3) and a circuit device (4). In one embodiment, the container (1) can be connected to a fuel cell (5) to supply hydrogen-rich liquid fuel for the fuel cell (5) to perform an electrochemical reaction by combining the hydrogen-rich fuel with oxygen and catalyst, so as to generate electric power output.

In this regard, the container (1) is hollow-structured and has a chamber to store the liquid fuel; the first sensor (2) and the second sensor (3) comprise means for measuring the liquid level respectively and are electrically connected to the circuit device (4) respectively, wherein the liquid level measuring means can be in a mechanical form, electrical form and any number of physical forms, enabling the liquid level information measured to be transmitted in the form of an electrical signal to the circuit device (4); the circuit device (4) has a logical calculator (41)with means for performing an electrical signal calculation, so as to convert the electrical signals related to the each liquid level information fed back from the first sensor (2) and the second sensor (3) into the quantity of liquid fuel.

The foresaid circuit device (4) can be set in the container (1) and with circuits arranged on a circuit board within the circuit device.

The foresaid apparatus for measuring the liquid level in a container of the fuel cell according to the embodiment of the present invention, the container (1) can be connected to a pump (6) where the liquid fuel is driven into the fuel cell (5) by the pump (6) for providing the fuel cell (5) with the liquid fuel required for conducting the electrochemical reaction. The first sensor (2), the second sensor (3) and the circuit device (4) in the container (1) can perform the calculation related to the quantity of liquid fuel remaining in the container, so as to determine whether the liquid fuel in the container (1) is sufficient, and provide a user with a reference to see if there is a need to supply the liquid fuel or to replace the fuel container with another one having sufficient liquid fuel.

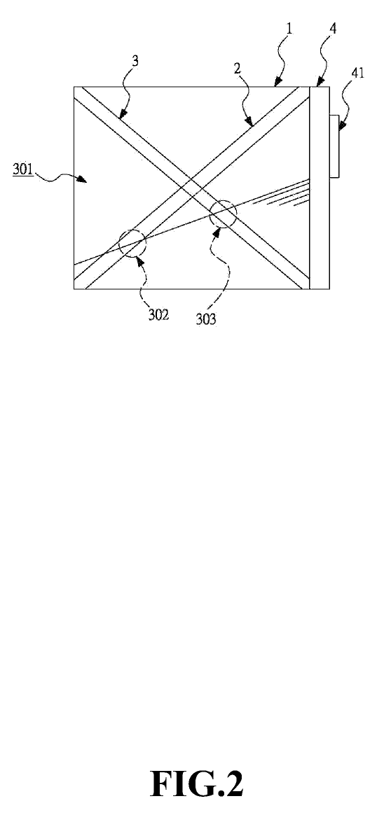

FIG. 2 is a plan view of the apparatus for measuring the liquid level in a container of the fuel cell device according to the first embodiment of the present invention. As shown in the FIG. 2, the first sensor (2) and the second sensor (3) can be defined as respective coordinate axes and a first reference plane (301) also can be defined according to the liquid level measured by the liquid level measuring means. Under the circumstances where the container (1) moves in the direction around the first reference plane (301), a first reference point (302) and a second reference point (303) can be measured by the first sensor (2) and the second sensor (3) respectively, and then the logical calculator (41) on the circuit device (4) is capable of converting the electrical signals related to the first reference point (302) and the second reference point (303) into the quantity of the liquid fuel remaining in the container.

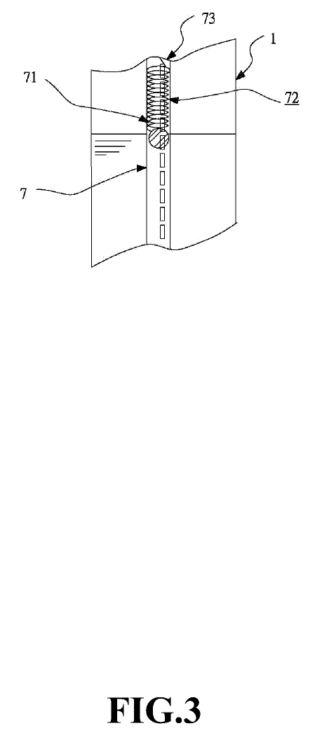

FIG. 3 is a plan view of a sensor for measuring the liquid level in a container of the fuel cell according to the embodiment of the present invention. As shown in FIG. 3, the first sensor (2) and the second sensor (3) stated above can adopt a mechanical liquid level measuring means. For instance, the liquid level measuring means of each sensor is composed of a hollow tube (7) and a float (71) pouched within the tube. In this regard, the tube (7) has a plurality of apertures penetrating the wall of the tube, causing a “communicating pipe effect” to be formed through the apertures (72) on the wall of the tube (7), which allow the fuel to enter the tube and to buoy up the float (71) to a height corresponding to the level of the liquid fuel in the container (1). In addition, the position of the float (71) can be converted into an electrical signal through the force feedback device by the elasticity generated by a spring (73). Therefore, as shown in FIG. 2, the first sensor (2) and the second sensor (3) can respectively obtain the electrical signals corresponding to the liquid level, which are the electrical signals related to the first reference point (302) and the second reference point (303), by the liquid level measuring means. Additionally, by means of geometric calculation, a linear equation corresponding to the first reference point (302) and the second reference point (303) can be obtained. Further suppose that the container (1) only rotates in the direction around the first reference plane (301), the liquid level can be obtained by the linear equation, such that the quantity of the liquid fuel remaining in the container (10) can be determined by means of integration.

In addition, the first sensor (2) and the second sensor (3) can also adopt a electrical liquid level detecting means, for example, the electric signals related to the first reference point (302) and the second reference point (303)can be obtained by measuring the resistance value (not shown).

The respective sensors, which are used in the method for measuring liquid level in the container of the fuel cell according to the embodiment of the invention, are not limited to employing the mechanical means or the electrical means for measuring the liquid level. It can also be performed by any number of physical measuring means only if the electrical signals measured can be converted into the electrical signals useful for the logical calculator (41) of the circuit device (4) according to the embodiment of the present invention.

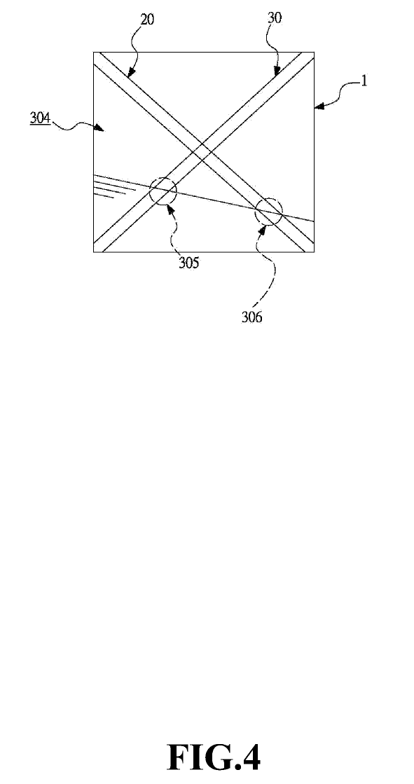

FIG. 4 is a plan view of the apparatus for measuring the liquid level in a container of the fuel cell according to the second embodiment of the invention. As shown in FIG. 4, the container (1) further comprises a third sensor (20), which can be defined as a coordinate axis according to the liquid level measured by the liquid level measuring means. Besides, the third sensor (20) is arranged out of the first reference plane (301) such that a third reference point (305) can be obtained by the third sensor (20). The logical calculator (41) on the circuit device (4) can define a geometric calculation of a plane by the three coordinate points, which converts the electrical signals related to the first reference point (302), the second reference point (303) and the third reference point (305) into a mathematical relationship and then determines the quantity of liquid fuel remaining in the container by means of integration.

In addition, the container (1) can further be arranged with a fourth sensor (30) which ca be defined as a coordinate axis according to the liquid level measured by the liquid level measuring means, wherein the fourth sensor (30) is out of the first reference plane (301) and a second reference plane (304) is defined by the projections of the third sensor (20) and the fourth sensor (30). Under the circumstances where the container (1) moves in the direction around the second reference plane (304), a third reference point (305) and a fourth reference point (306) can be measured by the third sensor (20) and the fourth sensor (30) respectively. The logical calculator (41) of the circuit device can convert the electrical signals related to the first reference point (302), second reference point (303), third reference point (305) and fourth reference point (306) into the quantity of liquid fuel remaining in the container.

Although the embodiment of the invention has been disclosed above, it is not taken to restrict the invention. Any one who is skilled in the art can alter and perfect the invention within the scope and claims of the invention, which can be seen in the attachment of claims of the invention.

What is claimed is:

1. A method for measuring the liquid level in a container of a fuel cell, comprising the steps of:
a. providing a container, a first sensor, a second sensor and a circuit device; wherein
the container has a chamber for storing the liquid fuel; the first sensor and the second sensor are respectively electrically connected to the circuit device and respectively comprise means for measuring the liquid level, so as to provide the liquid level information; the circuit device comprises a logical calculator with means for converting an electrical signal related to the liquid level information into an electrical signal related to the quantity of the liquid fuel;
b. defining the first sensor and the second sensor as respective coordinate axes according to the liquid level measured by the liquid level measuring means;
c. obtaining the liquid level information related to a first reference point and a second reference point corresponding to the respective defined coordinate axes by measuring the liquid level respectively via the first sensor and the second sensor; and
d. converting the electrical signals related to the respective reference points corresponding to the liquid level information into the remaining quantity of the liquid fuel by the logical calculator of the circuit device.

2. The method of claim 1, further comprising:
a. providing a third sensor, which is electrically connected to the circuit device and having means for measuring the liquid level so as to provide liquid level information;
b. arranging the third sensor in the container, and arranging the third sensor out of the reference plane made by the first sensor and the second sensor;
c. defining the third sensor as a respective coordinate axis according to the liquid level measured by the liquid level measuring means; and
d. obtaining the liquid level information related to a third reference point by measuring the liquid level via the third sensor.

3. The method of claim 1, further comprising:
a. providing a third sensor and a fourth sensor which are electrically connected to the circuit device and respectively having means for measuring the liquid level so as to provide liquid level information;
b. arranging the third sensor and fourth sensor in the container, and arranging the third sensor and fourth sensor out of the reference plane made by the first sensor and the second sensor;
c. defining the third sensor and fourth sensor as respective coordinate axes according to the liquid level measured by the liquid level measuring means; and
d. obtaining a third reference point and a fourth reference point corresponding to the liquid level information by measuring the liquid level via the third sensor and the fourth sensor.

4. An apparatus for measuring the liquid level in a container of fuel cell, comprising:
a container having a chamber for storing liquid fuel;
a first sensor having means for measuring the liquid level so as to provide liquid level information;
a second sensor having means for measuring the liquid level so as to provide liquid level information; and
a circuit device having a logical calculator;
wherein the first sensor and the second sensor are electrically connected to the circuit device respectively and the logical calculator has means for converting an electrical signal related to the liquid level information into an electrical signal related to the quantity of the liquid fuel.

5. The apparatus of claim 4, further comprising:
a third sensor; wherein the third sensor has means for measuring the liquid level so as to provide liquid level information and is electrically connected to the circuit device.

6. The apparatus of claim 4, further comprising:
a third sensor having means for measuring the liquid level so as to provide liquid level information; and
a fourth sensor having means for measuring the liquid level so as to provide liquid level information; wherein the third sensor and the fourth sensor are respectively electrically connected to the circuit device.

7. The apparatus of claim 4, wherein the circuit device is installed in the container and with circuits arranged on a circuit board within the circuit device.
